(19) United States
(12) Patent Application Publication
(10) Pub. No.: US 2012/0257520 A1
(43) Pub. Date: Oct. 11, 2012

(54) APPARATUS FOR POWER MANAGEMENT IN A NETWORK COMMUNICATION SYSTEM

(76) Inventors: Yuan-Hwa Li, Hsinchu County (TW); Chun-Hsien Pan, Hsinchu County (TW); Yi-Hung Chen, Hsinchu County (TW)

(21) Appl. No.: 13/083,616

(22) Filed: Apr. 11, 2011

(51) Int. Cl. H04W 52/02; H04L 12/26

(52) U.S. Cl. 370/252; 370/311

(57) ABSTRACT

An apparatus for power management in a network communication system including a legacy first network device is disclosed. The apparatus includes a second network device to serve as a client device to the first network device, a detector to generate a first signal if an idle status occurs in a first traffic from the first network device, and generate a second signal if a second traffic posterior to the first traffic is to be transmitted from the first network device, an identifier in response to the first signal to generate a third signal if the idle status exceeds a predetermined period of time, and a controller to disable the second network device in response to the third signal and hold the first network device from transmitting the second traffic in response to the second signal.

### BACKGROUND OF THE INVENTION

1. Field of the Invention

The present invention relates generally to network communication and, more particularly, to an apparatus for power management in a network communication system.

2. Description of the Prior Art

As the demand for high speed communication between personal computers grows, new-generation Ethernet protocol and devices have been developed for achieving higher data rate. For the new-generation Ethernet devices that operate at a high data rate, especially portable devices such as laptops, power consumption has been a major concern. Specifically, during a low traffic status wherein no downstream data packet from local medium access control (MAC) transmitter needs to be transmitted, idle patterns, i.e., physical layer (PHY) idle patterns used for synchronization of remote peer devices with local devices and for equalization of channel effects, are still transmitted from local PHY transmitter to the remote peer PHY receiver through a physical channel medium. For transmitting the aforementioned PHY idle patterns, the local PHY transmitter and remote peer PHY receiver need to continue operating and thus consume redundant power. Accordingly, a low power idle (LPI) protocol specified in IEEE 802.3 az. has been proposed so as to address the power consumption issue mentioned above.

FIG. 1A is a block diagram of an Ethernet communication system 100 that supports the LPI protocol when operating under a normal mode. Referring to FIG. 1A, considering only the transmission path from the local devices to the remote peer devices, for simplicity, the Ethernet communication system 100 includes a local MAC transmitter 11, a local PHY transmitter 10, a remote peer PHY receiver 16 and a remote peer MAC receiver 17. All the local MAC and PHY transmitters 11 and 10 and the remote peer MAC and PHY receivers 17 and 16 supports the LPI protocol. When operating under the normal mode wherein data packet needs to be transmitted, first, the local MAC transmitter 11 passes the data packet of interest to the local PHY transmitter 10 through media independent interface (MII) signals. Next, the local PHY transmitter 10 modulates the received data packets as data symbols which are then transmitted to the remote peer PHY receiver 16. Then, the remote peer PHY receiver 16 demodulates the received data symbols back to the data packet and the data packet will then be passed to the remote peer MAC receiver 17.

FIG. 1B illustrates a signal flow within the Ethernet communication system 100 illustrated in FIG. 1A when operating under a LPI mode. Referring to FIG. 1B, during a low traffic status wherein no downstream data packet from the local MAC transmitter 11 needs to be transmitted, the local MAC transmitter 11 may assert a TX_LPI signal that is to be transmitted to the local PHY transmitter 10. In response to the asserted TX_LPI signal, the local PHY transmitter 10, the remote peer PHY receiver 16 and then the remote peer MAC receiver 17 may sequentially enter the LPI mode. Unlike the legacy Ethernet devices, the local PHY transmitter 10 may stop generating and transmitting PHY idle patterns under the LPI mode. Therefore, the entire transmission path from the local MAC and PHY transmitters 11 and 10 to the remote peer PHY and MAC receivers 16 and 17 can enter a low power state wherein the local PHY transmitter 10 may be further disabled from operating. Thereby, power consumption in the Ethernet communication system 100 may be reduced.

With all the advantages in power management, however, the LPI protocol may only be applicable to new-generation Ethernet devices, for example, the MAC devices 11 and 17 and the PHY devices 10 and 16. In order to be compliant with the LPI protocol, MAC devices and PHY devices of older generations, i.e., legacy MAC devices and legacy PHY devices are required to be modified. However, the MAC devices are usually integrated into a system-on-a-chip (SOC). Modifying the MAC devices within the SOC so as to support LPI protocol will cause a great cost since the whole SOC may need to be re-designed and re-spun. On the contrary, the PHY devices are sometimes implemented as stand-alone chips apart from the SOC that contains the MAC devices. If an auto-LPI PHY device, i.e., a PHY device that is capable of initiating and proceeding the LPI protocol when coupling to the legacy MAC device may be provided, such power management can be achieved at low cost by merely replacing existing chip that contains legacy PHY device with an alternative one containing an auto LPI PHY device.

It may therefore be desirable to have an apparatus that is capable of modifying a legacy PHY device to be an auto-LPI PHY device.

### SUMMARY OF THE INVENTION

Examples of the present invention may provide an apparatus for power management in a network communication system including a legacy first network device. The apparatus comprises a second network device, which serves as a client device to the first network device, to operate in one of a first state, a second state and a third state, wherein the second network device is allowed to receive a first traffic from the first network device in the first state, disabled in the second state and recovered in order to receive a second traffic from the first network device in the third state, a detector to detect if the second traffic is to be transmitted from the first network device and generate a first signal as a request for the transmission of the second traffic, an identifier to identify if a low traffic status occurs in the first traffic and generate a second signal indicating the low traffic status, and a controller to switch the second network device among the first, second and third states, wherein the controller is configured to switch the second network device from the first state to the second state and disable the second network device in response to the second signal, and switch the second network device from the second state to the third state and hold the first network device from transmitting the second transmission traffic in response to the first signal.

Some examples of the present invention may also provide an apparatus for power management in a network communication system including a legacy first network device. The apparatus comprises a second network device to serve as a client device to the first network device, a detector to generate a first signal if an idle status occurs in a first traffic from the first network device, and generate a second signal if a second traffic posterior to the first traffic is to be transmitted from the first network device, an identifier in response to the first signal to generate a third signal if the idle status exceeds a predetermined period of time, and a controller to disable the second network device in response to the third signal and hold the first network device from transmitting the second traffic in response to the second signal.

Additional features and advantages of the present invention will be set forth in part in the description which follows, and in part will be obvious from the description, or may be learned by practice of the invention. The features and advantages of the invention will be realized and attained by means of the elements and combinations particularly pointed out in the appended claims.

It is to be understood that both the foregoing general description and the following detailed description are exemplary and explanatory only and are not restrictive of the invention, as claimed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1A is a block diagram of an Ethernet communication system that supports the LPI protocol when operating under a normal mode;

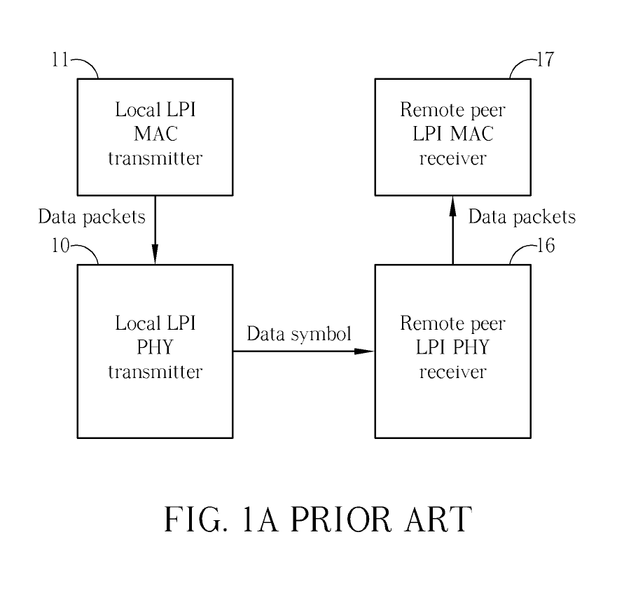

FIG. 1B illustrates a signal flow within the Ethernet communication system illustrated in FIG. 1A when operating under a LPI mode;

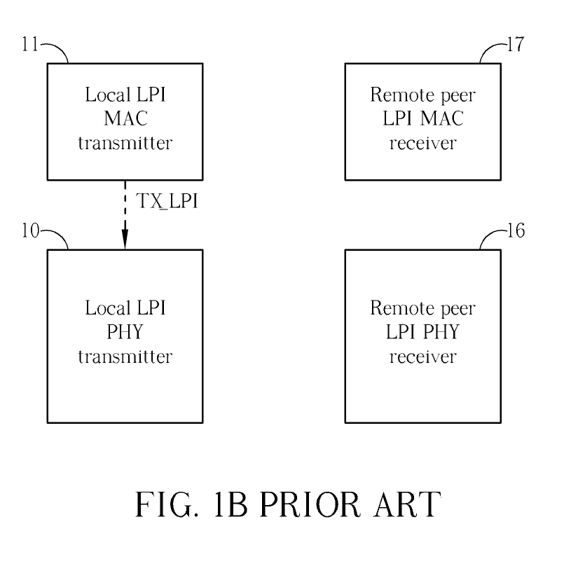

FIG. 2 is a block diagram of an apparatus for power management in a network communication system in accordance with an example of the present invention;

FIG. 3A is a timing diagram illustrating an exemplary operation of the apparatus illustrated in FIG. 2;

FIG. 3B is a schematic diagram illustrating an exemplary low traffic status;

FIG. 4A is a block diagram of an identifier illustrated in FIG. 2 in accordance with an example of the present invention;

FIG. 4B is a block diagram of a controller illustrated in FIG. 2 in accordance with an example of the present invention;

FIG. 4C is a diagram illustrating the transition of states in a state machine illustrated in FIG. 4B in accordance with an example of the present invention;

FIG. 4D is a timing diagram of an apparatus for power management in accordance with another example of the present invention;

FIG. 4E is a block diagram of a pause signal generator in accordance with another example of the present invention;

FIG. 4F is a timing diagram of an apparatus for power management in accordance with still another example of the present invention; and

FIG. 5 is a flow diagram illustrating a method of power management in a network communication system in accordance with an example of the present invention.

### DETAILED DESCRIPTION

Reference will now be made in detail to the present examples of the invention, examples of which are illustrated in the accompanying drawings. Wherever possible, the same reference numbers will be used throughout the drawings to refer to the same or like parts.

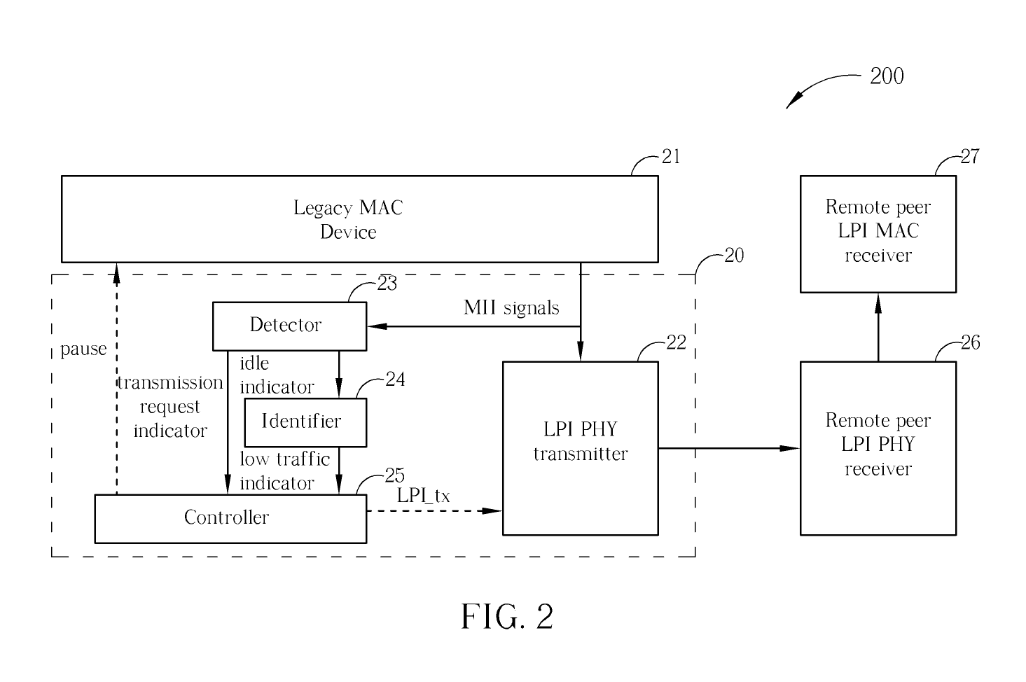

FIG. 2 is a block diagram of an apparatus 20 for power management in a network communication system 200 in accordance with an example of the present invention. Referring to FIG. 2, the system 200 may include, in addition to the apparatus 20, a first network device 21, for example, a legacy media access control (MAC) device, a remote low power idle (LPI) physical layer (PHY) transceiver 26 and a remote LPI MAC device 27. Throughout the specification, an “LPI” device refers to one that supports an LPI-mode operation specified in the communication standard of IEEE 802.3 az, while a “legacy” device refers to one that does not support the LPI-mode operation.

The apparatus 20, coupled to the first network device 21, may include a second network device 22, a detector 23, an identifier 24 and a controller 25. The second network device 22, for example, an LPI physical layer (PHY) transceiver 22, may receive downstream data packets from the first network device 21, and may be coupled with remote peer devices, that is, the remote LPI PHY transceiver 26 and in turn the remote LPI MAC device 27. The second network device 22 may receive from the first network device 21 at least one media independent interface (MII) data signal and at least one MII controlling signal associated with the at least one MII data signal.

The detector 23 may be configured to monitor the at least one MII data signal or the at least one MII controlling signal, generate a first signal, for example, an idle indicator for the identifier 24 and generate a second signal, for example, a transmission request indicator for the controller 25.

The identifier 24 may be configured to generate a third signal, for example, a low traffic indicator for the controller 25. Furthermore, the controller 25 may be configured to generate a fourth signal, for example, an LPI_tx signal for the second network device 22 and generate a fifth signal, for example, a pause signal for the first network device 21.

In one example according to the present invention, the second network device 22 may operate in one of a first, a second and a third states. Specifically, the second network device 22 may operate in an “ACTIVE” state, a “SLEEP” state and a “WAKE” state. When operating in the “ACTIVE” state, the second network device 22 may receive downstream data packets, i.e., a current burst of packets (or termed as “first traffic”), from the first network device 21. The current burst of packets may be transmitted in the form of the at least one MII data signal. Meanwhile, the detector 23 may monitor the at least one MII data signal or the at least one MII controlling signal and detect if there's an idle status associated with the current burst of packets.

Once an idle status is detected, the detector 23 may issue an idle indicator to the identifier 24 so as to instruct the identifier 24 to identify if there is a low traffic status associated with a downstream data flow that carries the downstream data packets. Furthermore, once a low traffic status associated with the downstream data flow is identified, the identifier 24 may issue a low traffic indicator to the controller 25 so as to instruct the controller 25 to assert the LPI_tx signal to a voltage level of logic high given the positive logic. In another example, the controller 25 may alternatively de-assert the LPI_tx signal to a voltage level of logic low given the negative logic. By asserting the LPI_tx signal, the controller 25 may instruct the second network device 22 to operate in the “SLEEP” state. When operating in the “SLEEP” state, the second network device 22 may enter the LPI mode, wherein the power consumption of the second network device 22 may be reduced.

Moreover, when the second network device 22 operates in the “SLEEP” state, the detector 23 may monitor the at least one MII controlling signal and thereby detect a request from the first network device 21 for transmitting the further incoming data packets, i.e., a next burst of packets (or, termed as “second traffic”). Once the request for transmitting the next burst of packets is detected, the detector 23 may issue a transmission request indicator to the controller 25 so as to instruct the controller 25 to de-assert the LPI_tx signal. By de-asserting the LPI_tx signal, the controller 25 may switch the second network device 22 to operate in the “WAKE” state. Moreover, when operating in the “WAKE” state, a recovery process may be performed for the second network device 22 so that the second network device 22 may be recovered from the LPI mode and ready to receive the next burst of packets from the first network device 21. In one example, the recovery process may include synchronizing the remote peer devices, i.e., the PHY transceiver 26 and the MAC device 27 at a remote site so that the remote peer devices may become ready for receiving the next burst of packets. Simultaneously, the controller 25 may be further instructed to assert a pause signal. By asserting the pause signal, the controller 25 may instruct the first network device 21 to hold from transmitting the next burst of packets for a time period until the second network device 22 is ready for receiving the next burst of packets.

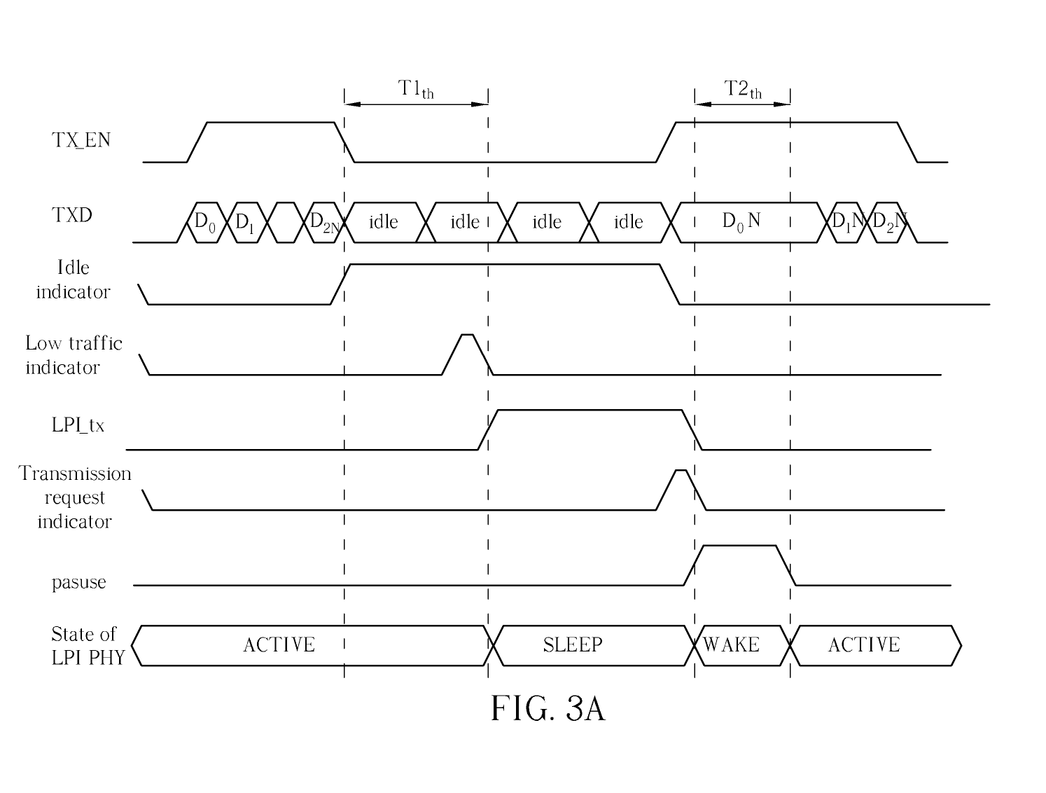

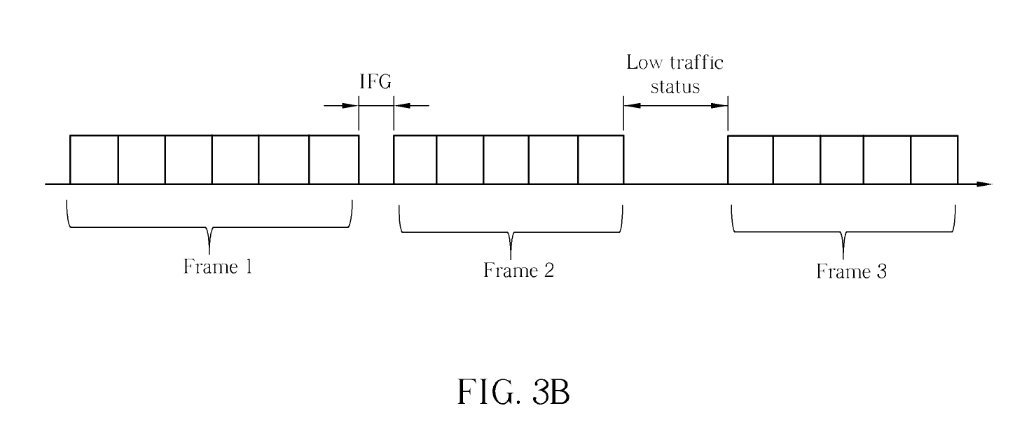

If the second network device 22 is recovered for receiving the next burst of packets, the controller 25 may be instructed to de-assert the pause signal so as to allow the first network device 21 to transmit the next burst of packets. Meanwhile, the controller 25 may switch the second network device 22 back to operate in the “ACTIVE” state where the second network device 22 may receive a subsequent burst of packets from the first network device 21. The detailed operation of the power management scenario for the apparatus 20 will be described in the following paragraph by reference to FIG. 3A.

FIG. 3A is a timing diagram illustrating an exemplary operation of the apparatus 20 illustrated in FIG. 2. Referring to FIG. 3A, the at least one MII data signal transmitted from the first network device 21 to the second network device 22 may include an MII signal “TXD” specified by IEEE 802.3, and the at least one controlling signal from the first network device 21 may include an MII signal “TX_EN” that is associated with “TXD”. Downstream data packets from the first network device 21 to the second network device 22 may be transmitted in the form of “TXD” with “TX_EN” that may denote the transmission status of the downstream data packets. For example, given positive logic being adopted, when the second network device 22 operates in the “ACTIVE” state and the data units (a data unit is formed as a 4-bit nibble): “D₀”, “D₁”, . . . and “D_{N}” of the current burst of packets in a downstream data flow that carries the downstream data are transmitted through “TXD”, “TX_EN” may be asserted to a voltage level of logic high, which denotes that the data units: “D₀”, “D₁”, . . . and “D_{N}” are in transmission.

Furthermore, when the transmission of the last data unit “D_{N}” of the current burst of packets is completed, “TX_EN” may be de-asserted to a logic-low voltage level, which denotes that the transmission of the current burst of packets is finished and no further downstream data packets in the current burst of packets are to be transmitted through “TXD.”

The detector 23 may monitor the voltage level of “TX_EN” and detects if there is an idle status associated with the current burst of packets. When a de-assertion of “TX_EN” is detected by the detector 23, an idle status associated with the data units “D₀”, “D₁”, . . . and “D_{N}” of the current packets may be thereby determined. The detector 23 may assert the idle indicator to logic high in response to the detection of an idle status. The idle indicator may retain in the logic high status through the whole idle period.

In one example, the payload of the downstream data packets may have been encoded as encoded bit patterns and transmitted through “TXD”. If no further downstream data packets are to be transmitted, idle patterns instead of the encoded bit patterns of the payload may be transmitted through “TXD”. Consequently, an idle status associated with the current burst of packets may be detected by monitoring the bit patterns transmitted through “TXD”. In that case, in one example, the detector 23 may include a comparator to compare bit patterns transmitted through “TXD” with idle patterns pre-stored in the detector 23. When the transmission of the last data unit “D_{N}” is completed, idle patterns transmitted through “TXD” may be monitored by the detector 23 and compared with those pre-stored in the detector 23. As a result, an idle status may be detected.

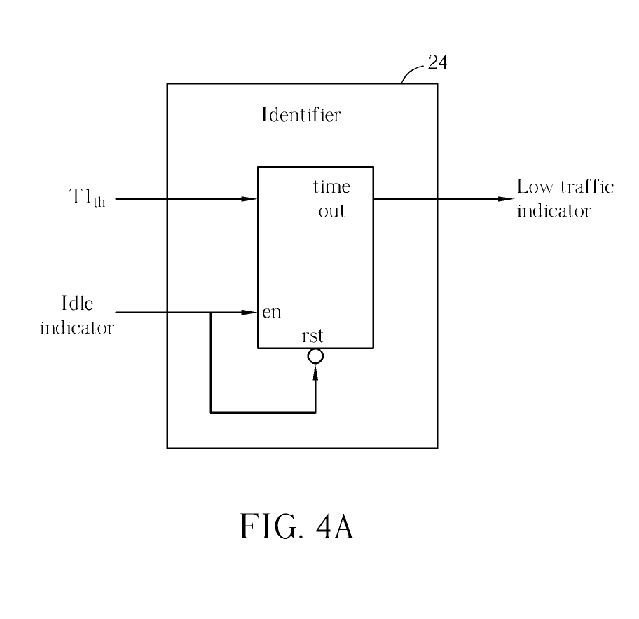

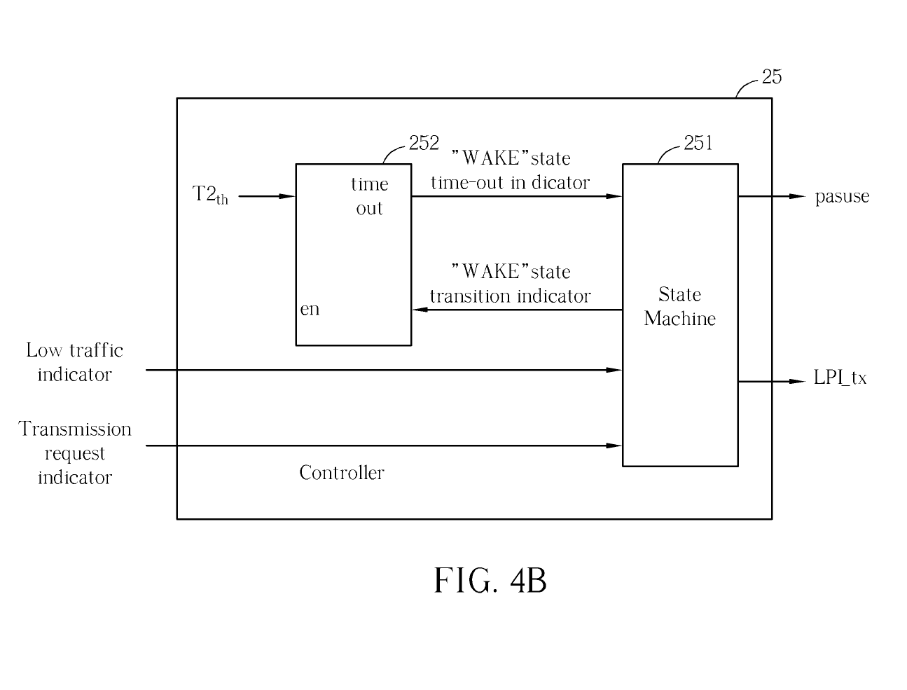

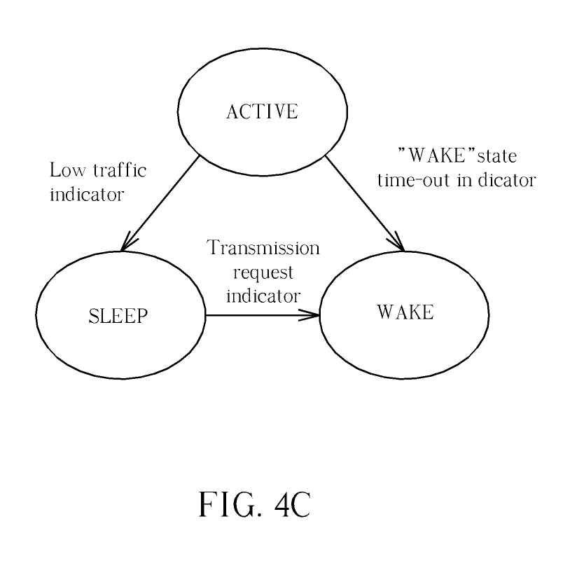

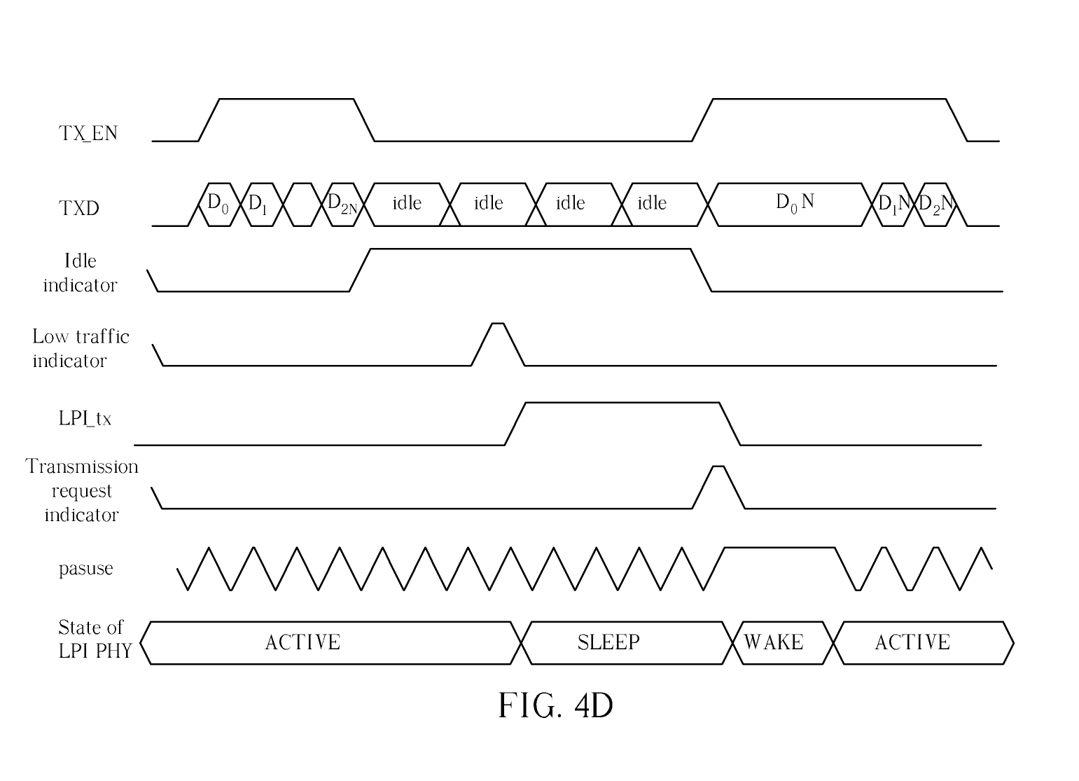

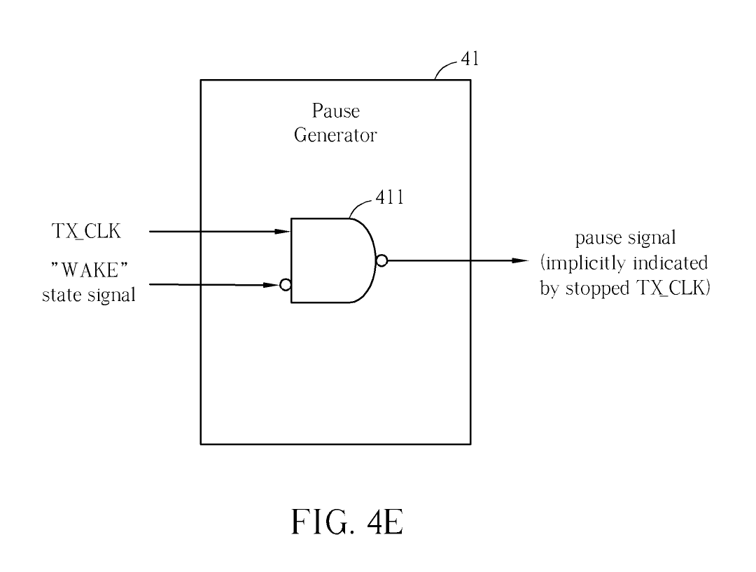

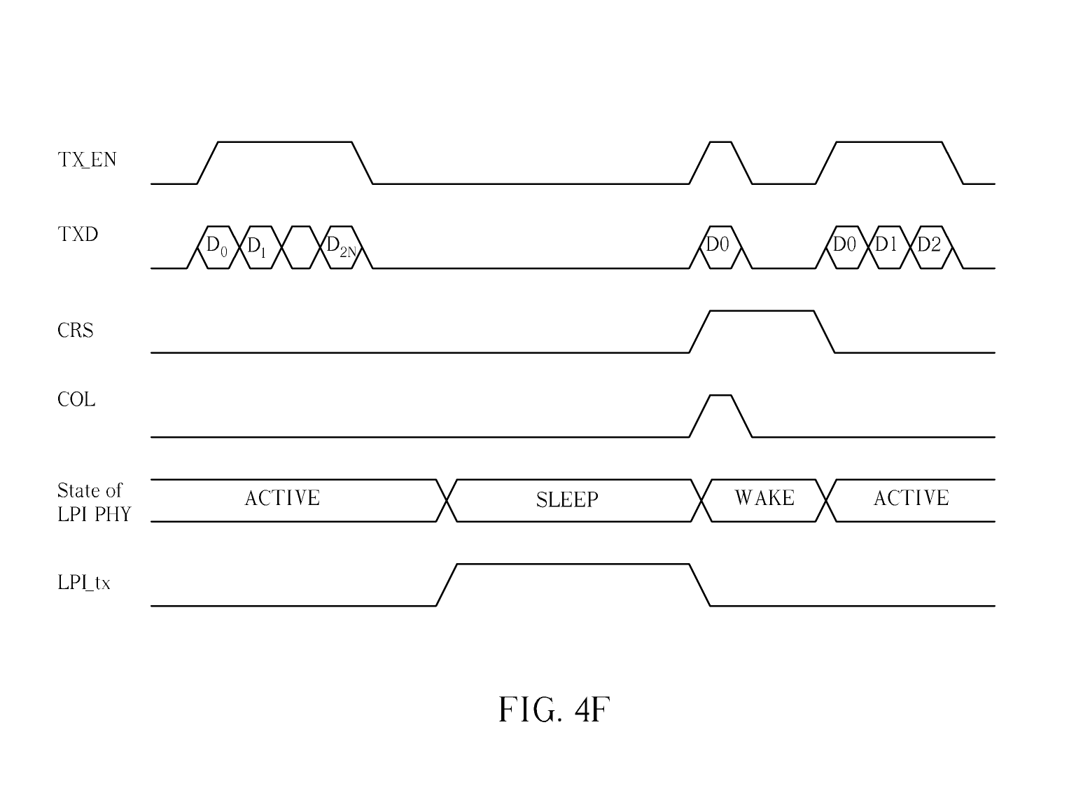

Furthermore, when an idle status is detected, the detector 23 may issue the idle indicator to the identifier 24, instructing the identifier 24 to identify whether there is a low traffic status associated with the downstream data flow that carries the burst of packets. Identification of the low traffic status will be discussed in the following paragraphs by reference to FIGS. 3B and 4A.

FIG. 3B is a schematic diagram illustrating an exemplary low traffic status. Referring to FIG. 3B, an inter frame gap (IFG) between two successive frames within a single burst of packets of the Ethernet system is specified as a predetermined value. For example, the IFG is specified as a 96-bit period. In one example according to the present invention, if the time without packet transmission immediately after an idle status associated with the single burst of packets being detected exceeds a first threshold, a low traffic status is identified. The first threshold, denoted as “T1ₜₕ” in one example may be set to a period of (IFG+1) bits. Accordingly, identification of a low traffic status associated with a downstream data flow may be achieved by counting the time from an idle status being detected and comparing the time with the first threshold T1ₜₕ. In one example, the identifier 24 may include a first timer 241 to count the time period, will be discussed later by reference to FIG. 4A.

Referring back to FIG. 3A, when a low traffic status is identified, since no further downstream data packets are to be received by the second network device 22, the second network device 22 may be switched to the “SLEEP” state where the second network device 22 will not receive any downstream data packets. Specifically, in response to a low traffic status being identified, the identifier 24 may assert a low traffic indicator and issue the low traffic indicator to the controller 25, instructing the controller 25 to assert an LPI_tx signal to a voltage level of logic high. By asserting the LPI_tx signal, the controller 25 may switch the second network device 22 from the ACTIVE state to the “SLEEP” state. Detailed description about how the controller 25 switches the second network device 22 among the ACTIVE, SLEEP and WAKE states will be discussed in later paragraphs by reference to FIG. 4B.

In the “SLEEP” state, the second network device 22 may enter the LPI mode and may then be disabled so that power consumption may be therefore reduced. In one example, the second network device 22 may be formed by digital integrated circuits including sequential logic elements. In that case, power consumption may be largely due to the toggling of clocks for the function of the sequential logic elements. Accordingly, the gated clocks, i.e., the conditionally running clocks to which most sequential logic elements may refer when functioning to receive the downstream data packets in the “ACTIVE” state, may be stopped from toggling so that the power consumption may be minimized. In another example, most of the elements within the analog front end (AFE) of the second network device 22 may be further disabled from operation so that power consumption may be further reduced.

Moreover, when the second network device 22 operates in the “SLEEP” state, the detector 23 may detect whether there is a request for the transmission of a next burst of packets. In one example, when the next burst of packets is to be transmitted from the first network device 21, “TX_EN” may be asserted again. The assertion of “TX_EN” may then be detected by the detector 23, which may subsequently assert a transmission request indicator and issue the transmission request indicator to the controller 25.

In response to the asserted transmission request indicator, the controller 25 may de-assert the LPI_tx signal, instructing the second network device 22 to leave from the LPI mode (i.e., SLEEP state) so as to receive the next burst of packets. However, before the second network device 22 is fully ready to receive the next burst of packets, a recovering process is needed to be performed to the second network device 22. Accordingly, immediately after de-asserting the LPI_tx signal, the controller 25 may instruct the second network device 22 to switch from the “SLEEP” state to a “WAKE” state wherein the recovering process may be performed.

Specifically, in the “WAKE” state, the recovering process may further include waking up the link partners, i.e., the remote peer LPI PHY receiver 26 using the physical layer LPI protocol. After a predefined period, the remote peer LPI PHY receiver 26 may be wakened up to be synchronized with the local transmitter, i.e., the second network device 22, and the second network device 22 may be fully ready to receive the next burst of packets from the first network device 21. To ensure the completion of the processing process, the duration of the “WAKE” state is required to be greater than a threshold, for example, a second threshold T2ₜₕ. In one example, the second threshold T2ₜₕ may be set as the aforementioned predefined period that allows the second network device 22 to be fully ready to receive the next burst of packets. (Therefore, the second threshold T2ₜₕ may be a designer's choice and may depend on how the second network device 22 is implemented and how long a period the synchronization process between the second network device 22 and the remote link partner is needed). Next, when the duration of the “WAKE” state exceeds the second threshold T2ₜₕ, the controller 25 may switch the second network device 22 to the “ACTIVE” state wherein the second network device 22 may start to receive the next burst of packets from the first network device 21.

Considering the behavior of the first network device 21 during the “WAKE” state, since the second network device is not ready to receive the next burst of packets from the first network device 21, the controller 25 may assert and issue the pause signal to the first network device 21 that may hold or stop the first network device from transmitting the next burst of packers. Specifically, the beginning of the next packet may be a sequence of preambles including a few data units D₀N to D₀32 (a data unit, for example, the first data unit D₀N is formed as a 4-bit nibble). The sequence preambles, i.e., the data units D₀N to D₀32 were early designed for synchronization purpose and were not expected to be completely received by the remote peer LPI PHY receiver 26. Therefore, it is acceptable to drop a certain amount of such preambles. Accordingly, in one example, the first (D₀N) or the following few data units D₁N, D₂N, etc. may be simply dropped before the first network device 21 is stopped from transmitting the next burst of packets (not shown in FIG. 3A). In another example, however, if it is desirable for the second network device 20 (and thus the remote peer LPI PHY receiver 26) to receive the whole packet without dropping any of the aforementioned preambles D₀N to D₀32, the first data unit D₀N (or the following few data units D₁N, D₂N, etc.) may be latched in the transmission pipeline or stored in a buffer (as shown in FIG. 3A). Then, after the second network device 20 is ready for receiving the next burst of packets from the first network device 21, the controller 25 may de-assert the pause signal that may in turn instruct and allow the first network device 21 to resume the transmission of the next burst of packets, no matter the first few data units of the first packet are dropped or to be transmitted.

FIG. 4A is a block diagram of the identifier 24 illustrated in FIG. 2 in accordance with an example of the present invention. Referring to FIG. 4A, the identifier 24 may, in response to the assertion of the idle indicator that is issued from the detector 23 when an idle status is detected, output a low traffic indicator to the controller 25 when a low traffic status is identified. The identifier 24 may include a first timer 241, which may be configured to count the time from an idle status being detected and identify if a low traffic status occurs. Specifically, the first timer 241 may comprise an input port “en” for enabling the first timer 241, a register (not shown in FIG. 4A) for registering a first configurable value, a reset port “rst” for resetting the first configurable value (reset to zero) and an output port “time out” for indicating a time-out condition.

In operation, the first timer 241 may be enabled by the idle indicator received at the input port “en”. Once the first timer 241 is enabled and starts to count the time, the first configurable value indicating the counted time registered in the register may be accumulated and compared with a first time-out threshold during the whole idle period. In one example, the first time-out threshold may be configured as the first threshold T1ₜₕ. If the first configurable value reaches the first time-out threshold, that is, the time from an idle status being detected exceeds the first threshold T1ₜₕ, the first timer 241 may issue a first time-out indicator through the output port “time out”. The first time-out indicator may then serve as a low traffic indicator.

FIG. 4B is a block diagram of the controller 25 illustrated in FIG. 2 in accordance with an example of the present invention. Referring to FIG. 4B, the controller 25 may, in response to a low traffic indicator from the identifier 24 and a transmission request indicator from the detector 23, output an LPI_tx signal to the second network device 22 and a pause signal to the first network device 21. The controller 25 may include a state machine 251 and a second timer 252.

The state machine 251 may receive the low traffic indicator, the transmission request indicator and a “WAKE” state time-out indicator from the identifier 24, the detector 23 and the second timer 252, respectively, and output the LPI signal and the pause signal based on the received low traffic indicator, transmission request indicator and “WAKE” state time-out indicator. Furthermore, the state machine 251 may schedule the transition of the operating states, i.e., the “ACTIVE” state, the “SLEEP” state and the “WAKE” state of the second network device 22. The second timer 252 may be configured to count the time that the second network device 22 stays in the “WAKE” state and output a “WAKE” state time-out indicator to the state machine 251 accordingly.

In one example, the state machine 251 may be a finite-state machine (FSM) having a first, a second and a third states corresponding to the “ACTIVE”, the “SLEEP” and the “WAKE” states of the second network device 22, respectively. Furthermore, the first, the second and the third states of the state machine 251 may be transited in the manner of “first to second”, “second to third” and “third to first”. The aforesaid transitions may be triggered by the low traffic indicator, the transmission request indicator and the “WAKE” state time-out indicator. The transitions will be discussed in detailed in the paragraph below by reference to FIG. 4C.

FIG. 4C is a diagram illustrating the transition of states in the state machine 251 illustrated in FIG. 4B in accordance with an example of the present invention. Referring to FIG. 4C, the state machine 251 may be initially set in the first state which corresponds to the “ACTIVE” state of second network device 22. When a low traffic indicator is received, the transition may be thereby triggered and the state machine 251 may switch from the first state to the second state. Furthermore, once entering the second state, the state machine 251 may immediately assert the LPI_tx signal. In response to the asserted LPI_tx signal, the second network device 22 may be thereafter switched from the “ACTIVE” state to the “SLEEP” state. Under the second state, in response to a transmission request indicator, the state transition of the state machine 251 may be triggered and the state machine 251 may switch from the second state to the third state. Once entering the third state, the state machine 251 may immediately de-assert the LPI_tx signal and assert the pause signal. In response to the de-asserted LPI_tx signal, the second network device 22 may be switched from the “SLEEP” state to the “WAKE” state accordingly. Furthermore, once entering the third state, the state machine 251 may immediately issue a “WAKE” state transition indicator to the second timer 252, instructing the second timer 252 to count the duration of the “WAKE” state as will be described later.

Under the third state, in response to a “WAKE” state time-out indicator, the state transition of the state machine 251 may be again triggered and the state machine 251 may then switch from the third state back to the first state. Once returning to the first state, the state machine 251 may immediately de-assert the pause signal. In response to the de-asserted pause signal, the second network device 22 may be switched back from the “WAKE” state to the “ACTIVE” state.

Referring back to FIG. 4B, the second timer 252 may be similar to first timer 241 illustrated in FIG. 4A except that, for example, the second timer 252 may be configured to receive the “WAKE” state transition indicator transmitted from the state machine 251 at an input port and enabled by the “WAKE” state transition indicator. Furthermore, the second timer 252 may include a second configurable value, which may be accumulated as the second timer 252 counts the duration of the WAKE state and compared with a second time-out threshold, which in one example is set as the second threshold T2ₜₕ. Moreover, once the second configurable value exceeds the second threshold T2ₜₕ, the second timer 252 may immediately issue the “WAKE” state time-out indicator through the output port. The “WAKE” state time-out indicator may then trigger a state transition that switches the state machine 251 from the third state to the first state.

FIG. 4D is a timing diagram of an apparatus for power management in accordance with another example of the present invention. Referring to FIG. 4D, the timing diagram may be similar to that illustrated in FIG. 3A except that, for example, a pause signal in the “WAKE” state, instead of being generated and issued by the state machine 251, may be alternatively provided by a MII clock signal such as the “TX_CLK” signal through a pause signal generator illustrated in FIG. 4E.

FIG. 4E is a block diagram of a pause signal generator 41 in accordance with another example of the present invention. Referring to FIG. 4E, the pause generator 41 may comprise an AND gate 411 with two input ports. The AND gate 411 may receive the “TX_CLK” at one input port and a “WAKE” state signal from the state machine 251 inverted at the other input port. Through the AND gate, the signal “TX_CLK” may be gated by the inverted “WAKE” state signal, and the pause generator 41 may thereby output a pause signal with a waveform as illustrated in FIG. 4D, when the “WAKE” state signal is asserted.

FIG. 4F is a timing diagram of an apparatus for power management in accordance with still another example of the present invention. Referring to FIG. 4F, when the second network device 22 operates in the “WAKE” state, the first network device 21 may be paused (or held) by a fake “COL” (collision) and then a fake “CRS” (carrier sensing) signals generated and transmitted by the second network device 22. The fake “COL” and “CRS” signals may fake a collision condition specified in IEEE802.3 that may in turn hold the first network device 21 from transmitting downstream data packets.

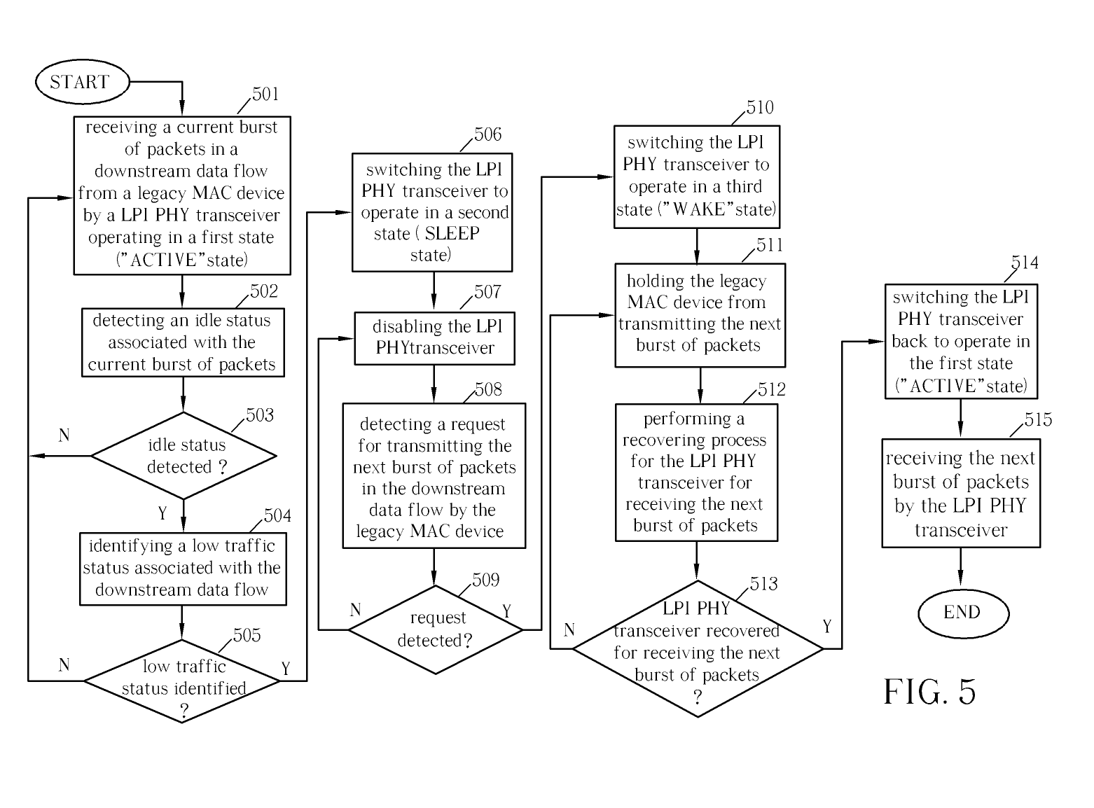

FIG. 5 is a flow diagram illustrating a method of power management in a network communication system in accordance with an example of the present invention. Referring to FIG. 5, at step 501, a first network device 21, for example, a legacy MAC device illustrated in FIG. 2, may transmit a burst of packets, i.e., a current burst of packets (or, termed as “first traffic”) in a downstream data flow in the form of a MII data signal, for example, “TXD” illustrated in FIG. 2 and FIG. 3A. The current burst of packets may then be received by a second network device 22, for example, a LPI PHY transceiver illustrated in FIG. 2 that may operate in a first state, for example, an “ACTIVE” state illustrated in FIG. 3A. Furthermore, a MII controlling signal, for example, “TX_EN” illustrated in FIG. 2 and FIG. 3A associated with the data signal “TXD” may be transmitted from the first network device 21 to the second network device 22.

Next, at step 502, during the period that the current burst of packets are under transmission, a detector 23 illustrated in FIG. 2 may monitor the bit patterns of “TXD” and the voltage level of “TX_EN” and thereby determine whether an idle status associated with the current burst of packets is detected. If idle patterns instead of encoded bit patterns that may carry the payload of the current burst of packets are transmitted or if “TX_EN” is de-asserted to a voltage level of logic low given the positive logic, an idle status associated with the current burst of packets is detected.

Next, at step 503, it is determined whether the idle status associated with the current burst of packets is detected. If confirmative, at step 504, an identifier 24 illustrated in FIG. 2 may then count the time from the idle status being detected, compare it with a first threshold T1ₜₕ illustrated in FIG. 3A and thereby determine whether a low traffic status associated with the downstream data flow is identified. If the time exceeds the first threshold T1ₜₕ, a low traffic status associated with the downstream data flow may be identified. Referring back to step 503, if an idle status associated with the current burst of packets is not detected, the method may return to step 501, at which the second network device 22 may keep receiving the current burst of packets from the first network device 21.

Next, at step 505, it is determined whether the low traffic status associated with the downstream data flow is identified. If yes, at step 506, the second network device 22 may be switched to operate in a second state, for example, a “SLEEP” state illustrated in FIG. 3A. If not, the method may return to step 501, at which the second network device 22 may keep operating in the “ACTIVE” state and receiving the current burst of packets from the first network device 21.

Next, at step 507, when operating in the second state, i.e., the “SLEEP” state, the second network device 22 may enter an LPI mode. As described previously, in the LPI mode, the second network device 22 may be disabled. By disabling the second network device 22, power consumption thereof may be reduced.

Next, at step 508, when the second network device 22 operates in the “SLEEP” state, the detector 23 may keep monitoring “TX_EN” so as to detect if there is a request for transmitting a next burst of packets (or, termed as “second traffic”) from the first network device 21. If the next burst of packets is to be transmitted from the first network device 21, “TX_EN” may be asserted to a voltage level of logic high, the request for transmitting the next burst of packets may be thereby detected.

Next, at step 509, it is determined whether the request for transmitting the next burst of packets is detected. If yes, at step 510, the second network device 22 may be switched to operate in a third state, for example, a “WAKE” state illustrated in FIG. 3A. If not, at step 507, the second network device 22 may keep operating in the “SLEEP” state and may be kept disabled. Furthermore, the detector 23 may keep detecting if there is a request for transmitting the next burst of packets.

Next, at step 511, when the second network device 22 operates in the “WAKE” state, the first network device 21 may be held from transmitting the next burst of packets because the second network device 22 is not ready for receiving the next burst of packets. That is, at steps 506 to 508, the second network device 22 is operating in the LPI mode and disabled from operation. As a result, at step 511, the second network is not recovered for receiving the next burst of packets.

Accordingly, at step 512, a recovering process may be performed for the second network device 22 so that the second network device 22 may be recovered from disablement and ready for receiving the next burst of packets.

Next, at step 513, it is determined whether the second network device 22 is recovered for receiving the next burst of packets. If confirmative, at step 514, the second network device 22 may be switched back to operate in the “ACTIVE” state. Subsequently, at step 515, the second network device 22 may perform the reception of the next burst of packets from the first network device 21. Referring back to step 513, if the second network device 22 is not ready for receiving the next burst of packets, at step 511, the second network device 22 may keep operating in the “WAKE” state.

It will be appreciated by those skilled in the art that changes could be made to the examples described above without departing from the broad inventive concept thereof It is understood, therefore, that this invention is not limited to the particular examples disclosed, but it is intended to cover modifications within the spirit and scope of the present invention as defined by the appended claims.

Further, in describing representative examples of the present invention, the specification may have presented the method and/or process of the present invention as a particular sequence of steps. However, to the extent that the method or process does not rely on the particular order of steps set forth herein, the method or process should not be limited to the particular sequence of steps described. As one of ordinary skill in the art would appreciate, other sequences of steps may be possible. Therefore, the particular order of the steps set forth in the specification should not be construed as limitations on the claims. In addition, the claims directed to the method and/or process of the present invention should not be limited to the performance of their steps in the order written, and one skilled in the art can readily appreciate that the sequences may be varied and still remain within the spirit and scope of the present invention.

Those skilled in the art will readily observe that numerous modifications and alterations of the device and method may be made while retaining the teachings of the invention.

What is claimed is:

1. An apparatus for power management in a network communication system including a legacy first network device, the apparatus comprising:
a second network device to operate in one of a first state, a second state and a third state, wherein the second network device is allowed to receive a first traffic from the first network device in the first state, disabled in the second state and recovered in the third state in order to receive a second traffic from the first network device;
a detector to generate a first signal if an idle status occurs in the first traffic and generate a second signal as a request for the transmission of the second traffic;
an identifier to identify if a low traffic status occurs in the first traffic and generate a third signal indicating the low traffic status; and
a controller to switch the second network device among the first, second and third states,
wherein the controller is configured to switch the second network device from the first state to the second state and disable the second network device in response to the third signal, and switch the second network device from the second state to the third state and hold the first network device from transmitting the second transmission traffic in response to the second signal.

2. The apparatus of claim 1, wherein the second network device includes an Ethernet physical layer (PHY) transceiver, which supports a low power idle (LPI) mode, and the legacy first network device includes a legacy Ethernet media access control (MAC) device, which does not support the LPI mode.

3. The apparatus of claim 1, wherein the identifier is configured to identify if the idle status exceeds a predetermined period of time.

4. The apparatus of claim 3, wherein the identifier includes a first timer to count the time from an idle status being detected and compare the time with a first threshold.

5. The apparatus of claim 1, wherein the controller includes a second timer to count the time of the third state and compare the time of the third state with a second threshold.

6. The apparatus of claim 5, wherein the controller is configured to switch the second network device from the third state to the first state when the time of the third state exceeds the second threshold.

7. The apparatus of claim 1, wherein the controller is configured to generate a pause signal in response to the second signal so as to hold the first network device from transmitting the second traffic.

8. The apparatus of claim 7, wherein the pause signal includes a gated clock signal.

9. The apparatus of claim 1, wherein the controller is configured to generate a fake collision (COL) signal and a fake carrier sensing (CRS) signal in response to the second signal so as to hold the first network device from transmitting the second traffic.

10. The apparatus of claim 1, wherein the detector is configured to monitor a bit pattern in the first traffic from the first network device in order to detect if an idle status occurs in the first traffic.

11. An apparatus for power management in a network communication system including a legacy first network device, the apparatus comprising:
a second network device to receive a first traffic and a second traffic posterior to the first traffic from the first network device;
a detector to generate a first signal if an idle status occurs in the first traffic and generate a second signal if the second traffic is to be transmitted from the first network device;
an identifier in response to the first signal to generate a third signal if the idle status exceeds a predetermined period of time; and
a controller to disable the second network device in response to the third signal and hold the first network device from transmitting the second traffic in response to the second signal.

12. The apparatus of claim 11, wherein the second network device includes an Ethernet physical layer (PHY) transceiver, which supports a low power idle (LPI) mode, and the legacy first network device includes a legacy Ethernet media access control (MAC) device, which does not support the LPI mode.

13. The apparatus of claim 11, wherein the second network device is configured to operate in one of a first state, a second state and a third state, wherein the second network device is allowed to receive the first traffic in the first state, disabled in the second state and recovered in the third state in order to receive the second traffic.

14. The apparatus of claim 11, wherein the identifier includes a first timer to count the time from an idle status being detected and compare the time with a first threshold.

15. The apparatus of claim 11, wherein the controller includes a second timer to count the time of the third state and compare the time of the third state with a second threshold.

16. The apparatus of claim 15, wherein the controller is configured to switch the second network device from the third state to the first state when the time of the third state exceeds the second threshold.

17. The apparatus of claim 11, wherein the controller is configured to generate a pause signal in response to the second signal so as to hold the first network device from transmitting the second traffic.

18. The apparatus of claim 17, wherein the pause signal includes a gated clock signal.

19. The apparatus of claim 11, wherein the controller is configured to generate a fake collision (COL) signal and a fake carrier sensing (CRS) signal in response to the second signal so as to hold the first network device from transmitting the second traffic.

20. The apparatus of claim 11, wherein the detector is configured to monitor a bit pattern in the first traffic from the first network device in order to detect if an idle status occurs in the first traffic.
